(19) United States
(12) Patent Application Publication
(10) Pub. No.: US 2003/0174354 A1
(43) Pub. Date: Sep. 18, 2003

(54) Method of and system for image processing of user registered data

(76) Inventor: Sugitaka Oteki, Tokyo (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/388,310

(22) Filed: Mar. 13, 2003

(30) Foreign Application Priority Data
Mar. 15, 2002 (JP) 2002-073331

(51) Int. Cl. G06K 15/02; H04N 1/21; H04N 1/40; G06T 3/40; G06F 13/00; G06F 3/12

(52) U.S. Cl. 358/1.13; 358/1.18; 358/1.2; 358/3.28

(57) ABSTRACT

In image processing of user registration data such as user-specified stamps, the efficient use of the document data and the user registration data is disclosed for multifunction machines such as copiers, facsimile machines, printers and scanners. The user registration data is scanned, and the scanned image is temporary stored for further processing such as enlargement and reduction. The original document is scanned only once for a series of image processes without being scanned a multiple of times.

### FIELD OF THE INVENTION

The current invention is generally related to image processing, and more particularly related to the efficient use of the document data and the user registration data in image processing in multi-function machines such as copiers, facsimile machines, printers and scanners.

### BACKGROUND OF THE INVENTION

Image processing devices process image data. Since the image processing devices have evolved to include multiple functions, the input image data is temporarily stored in a memory unit. The input document image data is converted to digital signal, and one page of an image is temporarily stored in a frame memory unit via a data bus. Alternatively, the image data is stored in secondary memory storage media such as a floppy disk or a hard disk.

At the time of printing, after one or more pages of the image data signal is transferred to the secondary memory unit, the image data signal is sent to a printer engine. At the print processing time, a digital copier receives a print command from a personal computer via local area network (LAN) and serial or parallel interface. While the font is being accessed, the printable image is generated in the frame memory unit, and the image signal is sent to the printer to obtain a print image.

Now referring to FIG. 9, Japanese Patent Publication Hei 9-186836 discloses a block diagram illustrating a conventional digital multi-functional device. The device includes two CPU's 901 and 902 for controlling the system as a whole. The device further includes a main memory unit 903 to store necessary font information and an application program that the CPU's 901 and 902 execute. A CPU bus 930 connect the CPU's 90 land 902 and the main memory 930. The above application program and the necessary font information are read from a secondary memory device 921 and are loaded in the main memory unit 903. The CPU bus 930 is connected to a PCI bus 931 via PCI bridge 904 and is connected to a PCI bus 932 via a PCI bridge 905. The CPU bus 930 is also connected to a PCI bus controller 906, which controls the arbitration between the PCI bus 931 supported by the PCI bridge 904 and the PCI bus 932 supported by the PCI bridge 905 and manages other controls in accordance with the PCI bus protocol.

Still referring to FIG. 9, the PCI bus 931 is connected to various other components such as a display controller 907 for controlling a display device 910, a touch panel controller 908 for controlling a touch panel 909, a FD/HD interface controller 911 for controlling secondary memory devices such as a floppy disk drive and a hard disk drive, a serial/parallel interface controller 912 for controlling serial and parallel communication with a host computer, and a network interface controller 913 for controlling communication with local area networks. Furthermore, the PCI bus 931 is connected to a DRAM controller 914 for managing read and write operations of an address in a frame memory 916 as well as managing a refresh control of the DRAM's that constitute a frame memory 917. On the other hand, the PCI bus 932 is connected to a DRAM controller 915 for managing read and write operations of an address in the frame memory 916 as well as managing a refresh control of the DRAM's that constitute a frame memory 917. In addition, the PCI bus 932 is connected to a DMA controller for controlling DMA transfer and a SCSI interface 920 for controlling a connection with a SCSI bus that is now shown in the diagram. The DMA controller 914 is connected to a DMA controller 918 and a video interface 919. Similarly, the DMA controller 915 is connected to the DMA controller 918 and the video interface 919. The DMA controller 918 transfers the image data in the frame memory 916 directly to the video interface 919 in accordance with the DMA control. In the alternative, the DMA controller 918 transfers the image data in the frame memory 917 directly to the video interface 919 in accordance with the DMA control. Although it is not shown in the diagram, the image data in the video interface 919 is outputted to the printer engine.

The operation of the above described digital copier will be described below with an assumption that multiple pages of the image data are scanned from a plurality of the documents and the multi-page image data is to be outputted for printing. The multi-page image data is inputted from a host computer via the serial/parallel interface controller 912. In the alternative, the character code and the control command are inputted via the network interface controller 913. The CPU 901 or 902 analyzes the multi-page image data. For example, the data is placed as bit image data in the frame memory 917. After one page of the image data is expanded, the CPU 901 initiates the DMA controller 918 and transfers the one-page image data in the frame memory 917 to the video interface 919. By the above transfer, the image data is outputted to the printer engine and is printed.

Now referring to FIG. 10, a system block diagram illustrates an image processing apparatus as disclosed in Japanese Patent Publication Hei 13-16902 as filed by the applicant. The image processing unit performs digital image processing and reproduces an image on image-transfer paper from the digital image signal. In fact, the image processing unit is a device for reproducing an image on image-transfer paper from the digital image signal from a scanner. An optical scanner 100 focuses the light reflected from an original document on photoreceptive elements via mirrors and lenses. The photosensitive elements such as CCD are placed on a sensor board unit 1002. The CCD converts the image signal into an electrical signal, and the electrical signal is converted into a digital signal. The digital signal is outputted from the sensor board unit 1002. The digital image signal from the sensor board 1002 is inputted into an image data control unit 1003. The image data control unit 1003 controls all of the data transfer between the data bus and the function device. The image data control unit 1003 also controls the image data transfer among the sensor board unit 1002, the parallel bus 1020 and the image processing processor 1004. In addition, the image data control unit 1003 controls the communication between a system controller 1031 for controlling the system as a whole and a process controller 1011 for the image data. The image signal from the sensor board 1002 is transferred to the image process processor 1004 via the image data control unit 1003. The image process processor 1004 corrects the signal degradation associated with the digitization and optical system and outputs the corrected data signal back to the image data control unit 1003. The corrected data is transferred from the image data control unit 1003 to an image memory access control unit 1021 via the parallel bus 1020. Based upon the control from the system controller 1031, the following tasks are accomplished, and the tasks include the access control for an image data and memory module 1022, the expansion for the print data for an external personal computer 1023 and the compression/decompression on the image data for the efficient memory utilization.

The data in the image memory access control unit 1021 is stored in a memory module 1022 after data compression, and the stored data is read as necessary. The read data is decompressed back to the original image data and is put back to the image data control unit 1003 from the image memory access control unit 1021 via the parallel bus 1020. After the transfer from the image data control unit 1003 to the image process processor 1004, the pulse control is performed at a video data control unit 1005 for image quality. An image formation unit 1006 forms a reproduced image on an image reproducing medium. As described above, according to the data flow, a multi-function machine is implemented by the bus control at the image data control unit 1003 and the parallel bus 1020. The FAX transmission function is performed by the image processing processor 1004 for scanning image data and by transferring the image data to the facsimile control unit 1024 from the image data control unit 1003 via the parallel bus 1020. At the facsimile control unit 1024, the data is converted for the communication networks, and the converted data is transmitted as FAX data in a public line. The FAX reception is performed by converting the line data from the public line 1025 to the image data by the facsimile control unit 1024 and by transferring the image data to the image processing processor 1004 via the image data control unit 1003 and the parallel bus 1020. In the above case, no special image processing takes place, and the dot arrangement and the pulse control are performed at the video data control 1005. The image formation unit 1006 forms a reproduced image on the transfer paper.

For example, the above multiple tasks include a copy function, a fax transmission/reception task and a printer output function, and they are performed in parallel. Under the parallel task performance, the system controller 103 and the process controller 1011 control the interrupt for using the scanner unit 1001, the image forming unit 1006 and the parallel bus 1020 among the concurrent tasks. The process controller 1011 controls the image data flow while the system controller 1031 controls the system as a whole by managing the resources. The function selection of the multiple functions is inputted via an operation panel 1034, and the selected process such as a copy function and a fax function is set up. A serial bus 1010 includes a RAM 1012 and a ROM 1013 for the process controller 1011. The system controller 1031 and the process controller 1011 communicate with each other via the parallel bus 1020, the image data control unit 1003 and the serial bus 1010. In the image data control unit 1003, the image data is converted in its data format for the data interface between the parallel bus 1020 and the serial bus 1010.

Now referring to FIG. 11, a block diagram illustrates the components of a conventional image processing processor 1004. The scanned image is transferred from the input I/F 1101 of the image processing processor 1004 to a scanner image processing unit 1102 via the sensor board unit 1002 and the image data control unit 1003. The shading correction, the scanner y correction and the MTF correction are performed on the scanned image signal in order to correct the degradation. Although it is not a part of the correction process, the image signal also undergoes the variable size change for enlargement and reduction. After the completion of the scanned image data, the image data is transferred to the image data control unit 1003 via an output I/F 1103.

The output to an image transfer sheet involves an area gradation process at an image quality process unit 1105 after receiving the image data from the image data control unit 1003 via an input I/F 1104. The image quality processed data is outputted to the video data control unit 1005 via an output I/F 1106. The area gradation process involves an intensity conversion, a dithering process and an error diffusion process, and the area approximation of the gradation information is a major task. Since the image data that has been image processed by the scanner is temporarily stored in memory, various images are reproduced by modifying the image process. For example, the intensity of the reproduced image is modified or the number of lines is changed in dithering. The reproduced image appears differently. In these variations, it is not necessary to read the image data from the scanner unit 1001 since the stored image data is retrieved from the memory module 1022. It is possible to perform various processes on the same data as many times as desired. When a single scanner is used, the scanner image processing and gradation processes are combined, the result is sent to the image data control unit 1003. The processing content is programmable. The changes in the process switch and the processing order are managed by a command control unit 1107.

Now referring to FIG. 12, a block diagram illustrates the components of a conventional image data control unit 1003. An image data input output control unit 1201 inputs the image data from the sensor board unit 1002 and outputs the image data to the image processing processor 1004. The image data that has been corrected by the image processing processor 1004 is inputted into an image data input control unit 1202. The input data is compressed by a data compression unit 1203 to increase the transmission efficiency rate in the parallel bus 1020 and is transmitted to the parallel bus 1020 via a parallel data I/F 1205. Since the input image data from the parallel bus 1020 via the parallel data I/F 1205 is already compressed for the bus transmission, the compressed image data is decompressed or expanded in a data decompression unit 1206. The decompressed image data is transferred to the image processing processor 1004 by an image data output control unit 1207. A data conversion unit 1204 has a conversion function for the serial data as well as the parallel data. The system controller 1031 transfers the data to the parallel bus 1020. The process controller 1011 transfers the data to the serial bus 1010 via a serial data I/F 1208. As described above, the data is converted for the communication between the two controllers. A serial data I/F 1209 is for the image processing processor 1004 for transferring the data to the image processing processor 1004. A command control unit 1210 controls the components and the interfaces in the image data control unit 1003 according to the input command.

Now referring to FIG. 13, a block diagram illustrates the components of a conventional video data control unit 1005. The input image data is processed by additional processes according to the characteristics of the image forming unit 1006. An edge smoothing unit 1301 performs a rearrangement of the dots while a pulse control unit 1302 performs a pulse control of the image signal for the dot formation. The processed image data is outputted to the image forming unit 1006. Independent of the image data conversion, the format conversion function for the parallel data and the serial data exist in the combination of a parallel data I/F 1303, a serial data I/F 1304 and a data conversion unit 1305. A single video data control unit 1005 alone takes care of the communication between the system controller 1031 and the process controller 1011.

Now referring to FIG. 14, a block diagram illustrates the components of a conventional image memory access control unit 1021. The parallel data I/F 1401 manages the interface the image data with the parallel bus 1020. The image memory access control unit 1021 controls the read from and the store of the image data in the memory module 1022 as well as controls the expansion of the code data from the external personal computer (PC) 1023 into the image data. The inputted code data from the PC 1023 is stored in a local area in a line buffer 1402. The code data in the line buffer 1402 is expanded to the image data in a video controller 1404 based upon an expansion command inputted from the system controller 1031 via a system controller I/F 1403. The expanded data or the input image data from the parallel bus 1020 via a parallel data I/F 1401 is stored in the memory module 1022. The image data is selected for the storage in the data conversion unit 1405 and is compressed by a data compression 1406 in order to increase the memory utilization efficiency rate. A memory access control 1407 manages the addresses in the memory module 1022 and stores the image data in the memory module 1022. The memory access control unit 1407 controls the read address for reading the stored image data from the memory module 1022, and a data decompression unit 1408 decompressed the image data read from the memory module 1022. When the decompressed image data is sent to the parallel bus 1020, the image data is transferred via the parallel I/F 1401.

Now referring to FIG. 15, a block diagram illustrates the components of a conventional facsimile control unit 1024. The facsimile control unit 1024 converts the image data into a predetermined communication format. The facsimile control unit 1024 transfers the formatted data to an external line. Conversely, the facsimile control unit 1024 converts the data from the outside back to the image data and outputs the image data for the record from the image forming unit 1006 via the parallel bus 1006 and the external I/F 1501. The facsimile control unit 1024 includes a FAX image processing unit 1502, an image memory 1503, a memory control unit 1504, a facsimile control unit 1505, an image compression/decompression unit 1506, a modem 1507 and a net control unit 1508. The edge smoothing unit 1301 of the video data control unit 1005 performs the binary smoothing process on the received image during the FAX image process. With respect to the output buffer function of the image memory 1503, a part of the function is transferred to the image memory access control unit 1021 and the memory module 1022. In the above constructed facsimile control unit 1024, the facsimile control unit 1505 instructs the memory control unit 1504 when the transmission of the image information begins. The image information is sequentially read from the image memory 1503. The read image information is converted back to the original signal by the FAX image processing unit 1502. The density conversion process and the variable scaling process also take place, and the image data is added to the facsimile control unit 1505. The signal added in the facsimile control unit 1505 is coded and compressed by the image compression/decompression unit 1506 and is transferred to a destination via the net control unit 1508 after modulated by the modem 1507. The image information is removed from the image memory 1503 after the transmission is completed.

Still referring to FIG. 15, at the reception, the received image is temporarily stored in the image memory 1503. If it is possible to output for recording, one page of the received image data is outputted for recording when the one page reception is completed. When the reception starts during a copying operation, the receiving image data is stored in the image memory 1503 until the utilization rate reaches a predetermined value such as 80%. Upon reaching the predetermined utilization rate, the writing operation is forcefully interrupted, and the stored reception image is read out from the image memory 1503 for recording in an output. The reception image from the image memory 1503 is deleted from the image memory 1503. When the utilization rate reaches a certain value such as 10%, the interrupted writing operation is resumed. Upon completing the writing operation, the remaining received image is outputted for recording. In interrupting the writing operation, in order to resume the writing operation, the interrupted writing operation is internally saved in various parameters. Upon restarting the interrupted writing operation, the parameters are internally returned. In the system of the image processing device, during the copying operation, the image signal scanned by the scanner 1001 is transferred to the board unit 1002, the image data control unit 1003, the image processing processor 1004 and then back to the image data control unit 1003. The image data is transferred from the image data control unit 1003 and is stored in the memory module 1022 via the parallel bus 1020 and the image memory access control unit 1021. The image signal is subsequently transferred from the memory module 1022 to the image data control unit 1003 via the image memory access control unit 1021 and the parallel bus 1020. The image data is further transferred to from the image processing processor 1004 and the video data control unit 1005 in order to obtain a transferred image.

Now referring to FIG. 16, a diagram illustrates one of the copier functions that is related to a user stamp to be formed. Original documents (a) and (c) each contain a character “A.” A predetermined secret stamp “s” is printed in an upper right corner of the document (a) as shown in the processed document (b). For example, commonly used user-defined stamps include “s” for secret, “c” for later collection and “fyi” for review, “no copy” for prohibiting duplication and “urgent” for urgent review, and these predetermined stamps have been registered with the multi-function device. By selecting one of these predetermined stamps, a copy is completed from the original document with the selected stamp. In addition to the above exemplary user-common stamps, some user-specific stamps are also printed on the copy. For example, one exemplary user-specific stamp (d) indicates a name of the XYZ company. The above user-specific stamp is registered with the copier and is used as one of the pre-registered common or general stamps.

Now referring to FIG. 17, a diagram illustrates one exemplary user-specific stamp. In general, three sizes of the user-specific stamp are separately pre-registered with a copier even though the stamp contains the exactly the same content information.

Depending upon the size of the original document, one of these three sizes is used. As shown in a user-specific stamp (a), when an original document is to be registered as a user-specific stamp in the scanner unit 1001, the original document data is scanned in as a set as if it is being copied. For example, at the time of scanning, the original document is scanned at the resolution of 600 dots per inch (dpi). When a copy is made at the equal size, a user stamp (b) is obtained. However, a copy is reduced to 67% or 33%, a user stamp (c) or (d) is respectively obtained.

Now referring to FIG. 18, a block diagram illustrates the components of a conventional scanner. The diagram also illustrates a data flow in scanning an original. In conjunction with FIG. 18, FIG. 19 illustrates a data process for each of the original scanning situations. The user specific stamp image in the scanner unit 1001 receives an equal size or the unmodified size in a first scan flow in the order of the scanner unit 1001, the sensor board unit 1002, the image data control unit 1003, the image processing processor 1004, the image data control unit 1003, the image memory access controller 1021 and the memory module 1022. In a second scan flow, the scanner unit 1001 scans again scans the stamp original and sends the scanned image data to the memory module 1022 in the same path as in the first scan flow. However, the image is reduced to 67% by the image data control unit 1003 or the image processing processor 1004, and the reduced image stamp is obtained. Furthermore, in a third scan flow, the scanner unit 1001 scans again scans the stamp original and sends the scanned image data to the memory module 1022 in the same path as in the first scan flow. However, the image is reduced to 33% by the image data control unit 1003 or the image processing processor 1004, and the further reduced image stamp is obtained. The above illustrates the registration of the three sizes of the user specified stamps.

FIG. 20 illustrates original documents to be used in a predetermined consolidation process. FIG. 21 illustrates a consolidated image of the original documents in FIG. 20 after the predetermined consolidation process. The consolidation process is a mode in which a plurality of original documents is copied onto a single image transferring sheet. For example, FIG. 20 illustrates four separate original documents (a), (b), (c) and (d). The original documents (a) and (d) are in A4 size while the original documents (b) and (c) are in A3 size. When the total of four documents in A3 and A4 are scanned by the scanner unit 1001 and the four-in-one consolidation process is performed, the four original documents are transferred onto a single A3 sheet. In the above consolidation, each original document is uniformly reduced to the A5 size. During the above consolidation, an original document data size is detected by the scanner unit 1001. When the document size A4 is detected, the document is reduced from the A4 size to the A5 size at the reduction rate of 71%. Similarly, when the document size is A3, the document is reduced from the A3 size to the A5 size at the reduction rate of 50%. The scanner unit 1001 has to detect the original document size. If the document size is the same, when the documents are placed on the scanner unit 1001, the size is detected by a sensor such as an optical sensor.

FIG. 22 illustrates an image separation from an original document. For example, a character “B” is taken out from an original document (a), and an enlarged image (b) is duplicated from the isolated image.

Despite the above prior art disclosures, as shown in FIG. 19, in order to obtain various sizes of the user specified stamp, the same stamp has to be scanned a multiple of times. As the number of scanning increases, the mechanical deterioration is experienced and the user operation is also wasted. For these reasons, the various sizes of the same user specified stamp were not easily obtained. By the same token, in the consolidation process for a mixture of the original document sizes as shown in FIG. 20, only the largest size was detected. If the document size is not correctly detected, the size modification is not determined. To determine the document size, it is necessary to have a mechanical means to detect an edge of the original document. After the document size is detected, it is possible to initiate the scanning process of the original document. When a mixture of the sizes exists in the original documents and the size is to be detected by the scanner unit 1001, the structure of the scanner unit 1001 becomes complex and physically large. Not only the space is saved, but also the cost increases. Furthermore, the scanning speed decreases.

When a portion of the original document image is to be separated as shown in FIG. 22, the user must scan the image with respect to the origin of the scanner unit 1001. When the origin is not correctly aligned, the copy image is also not correctly aligned. As a result, it has been a problem that the isolation of the desired image is not precise.

For the above reasons, it remains desired to solve the currently existing problems by efficiently utilizing the scanned original document image data and the scanned user specified registration data in order to perform the consolidation, enlargement, reduction and separation processes.

### SUMMARY OF THE INVENTION

In order to solve the above and other problems, according to a first aspect of the current invention, an image processing apparatus including: a controller block having a converter for converting scanned image data of an original document to digital image signal, the controller block having an image memory for storing the digital image signal; and an engine block connected to the controller block for processing the digital image data, the engine block having a temporary memory for storing the digital image data, the engine block retrieving the digital image from the temporary memory for further processing.

According to a second aspect of the current invention, a method of image processing including the steps of: converting scanned image data of an original document image to a digital image signal in a control block; processing the digital image to a usable image signal in the control block; storing the usable image signal in an image memory in the control block; storing the image signal in a temporary memory in an engine block; reading the image signal from the temporary memory in response to a request from the control block; and transferring the image signal from the temporary memory to the control block.

According to a third aspect of the current invention, a method of duplicating user specified stamps, including the steps of: scanning a user specified stamp to generate image data; storing the image data in a temporary storage; reading the image data from the temporary storage; processing the image data read from the temporary storage based upon a parameter; and repeating said reading and processing steps with a different value in the parameter.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating one preferred embodiment of a system of the image processing device according to the current invention.

FIG. 2 is a block diagram illustrating the components of the image data control unit 1003A in the preferred embodiment according to the current invention.

FIG. 3 is a block diagram illustrating the components of a preferred embodiment of the scanner.

FIG. 4 is illustrating a data process for registering user-specified stamps.

FIG. 5 is a block diagram illustrating the components of the image processing system and a data flow among the components for processing original documents in a mixture of various document sizes according to the current invention.

FIG. 6 is a diagram illustrating a process of separating a partial image.

FIG. 7(a) is a block diagram for controlling data in compressing data at the data compression unit 1203 in the image data control unit 1003A.

FIG. 7(b) is a timing chart illustrating the first through third lines of the image being read from the line FIFO's 701 through 703 and inputted in the data compression device 704 to obtain the compressed data.

FIG. 8 is a table illustrating an exemplary data compression at the data compression device.

FIG. 9 is a block diagram illustrating a conventional digital multi-functional device.

FIG. 10 is a system block diagram illustrating an image processing apparatus as disclosed in Japanese Patent Publication Hei 13-16902 as filed by the applicant.

FIG. 11 is a block diagram illustrating the components of a conventional image processing processor 1004.

FIG. 12 is a block diagram illustrating the components of a conventional image data control unit 1003.

FIG. 13 is a block diagram illustrating the components of a conventional video data control unit 1005.

FIG. 14 is a block diagram illustrating the components of a conventional image memory access control unit 1021.

FIG. 15 is a block diagram illustrates the components of a conventional facsimile control unit 1024.

FIG. 16 is a diagram illustrating one of the copier functions that is related to a user stamp to be formed.

FIG. 17 is a diagram illustrates one exemplary user-specific stamp.

FIG. 18 is a block diagram illustrating the components of a conventional scanner.

FIG. 19 is illustrating a data process for each of the original scanning situations.

FIG. 20 is illustrating original documents to be used in a predetermined consolidation process.

FIG. 21 is illustrating a consolidated image of the original documents in FIG. 20 after the predetermined consolidation process.

FIG. 22 is illustrating an image separation from an original document.

### DETAILED DESCRIPTION OF THE PREFERRED EMBODIMENT(S)

Based upon incorporation by external reference, the current application incorporates all disclosures in the corresponding foreign priority document (Japanese Patent Application 2002-073331) from which the current application claims priority.

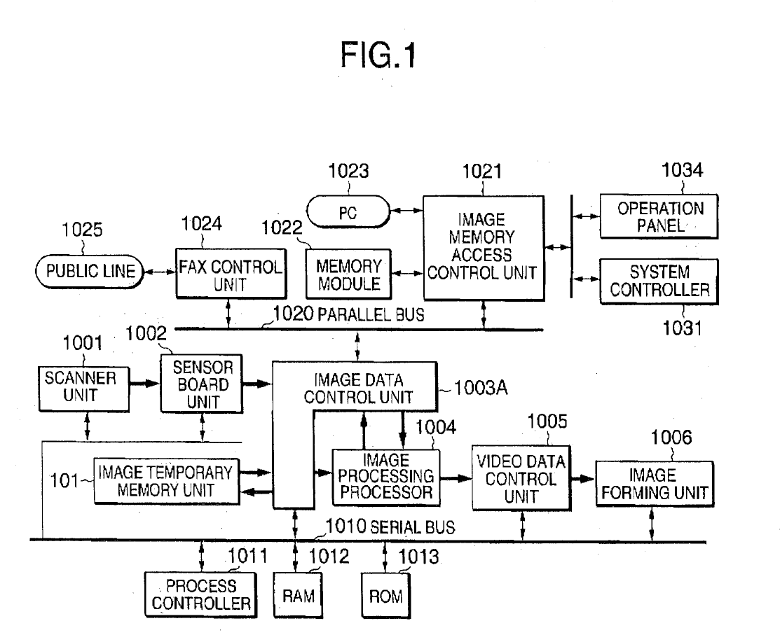

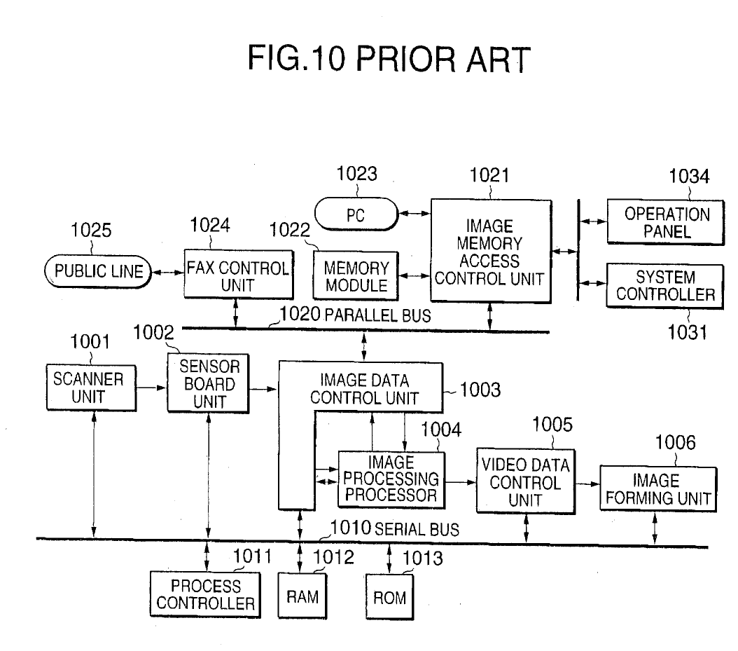

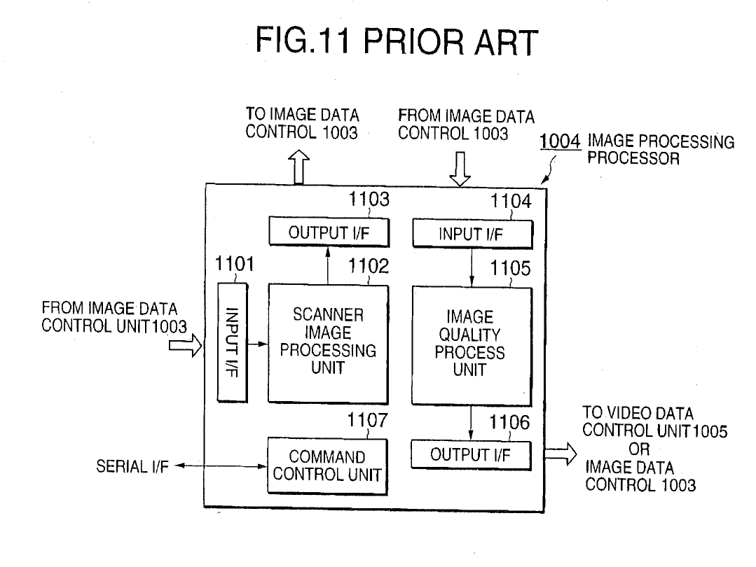

Referring now to the drawings, wherein like reference numerals designate corresponding structures throughout the views, and referring in particular to FIG. 1, a block diagram illustrates one preferred embodiment of a system of the image processing device according to the current invention. The preferred embodiment as shown in FIG. 1 shares substantially identical components as shown in the prior art system of FIG. 10. These substantially identical components are referred to by the same reference numerals between FIGS. 1 and 10. The first preferred embodiment differs from the prior art devices in that the preferred embodiment includes a temporary memory unit 101 and that an image data control unit 1003A is connected to the temporary memory unit 101. The image data control unit 1003A in the preferred embodiment is also different from the image control unit 1003 of the prior art device. A controller side includes units illustrated above the parallel bus 1020 and contains an image memory access control unit 1021, a memory module 1022 and a facsimile control unit 1024. On the other hand, an engine side includes units illustrated below the parallel bus 1020 and contains a scanner unit 1001, a sensor board unit 1002, an image data control unit 1003A, an image processing processor 1004, a video data control unit 1005 and an image forming unit 1006. In the preferred embodiment, the engine side also now has some memory in the temporary memory unit 101.

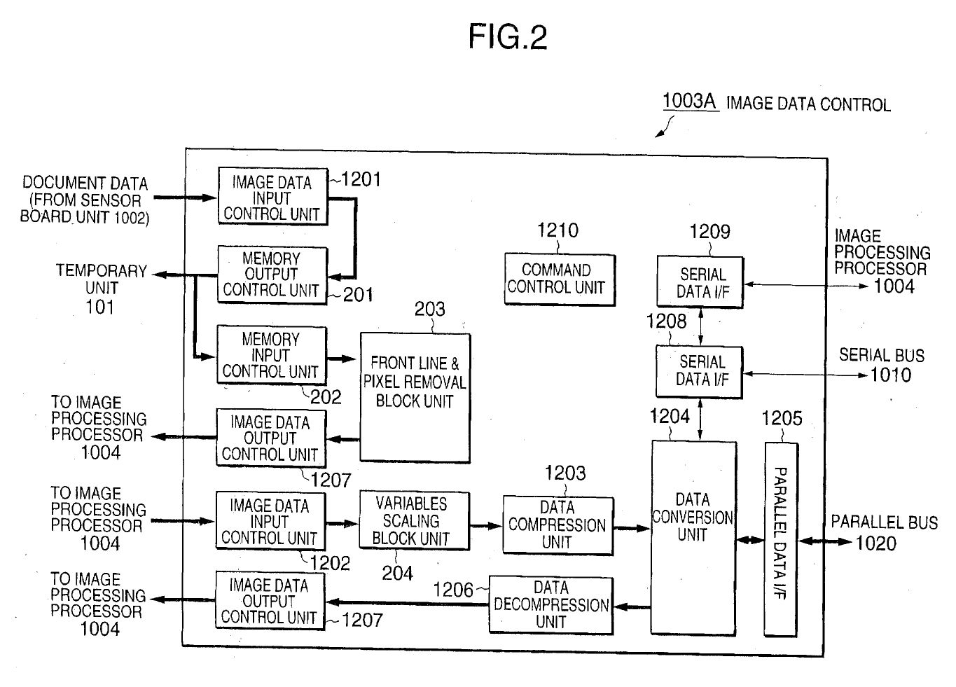

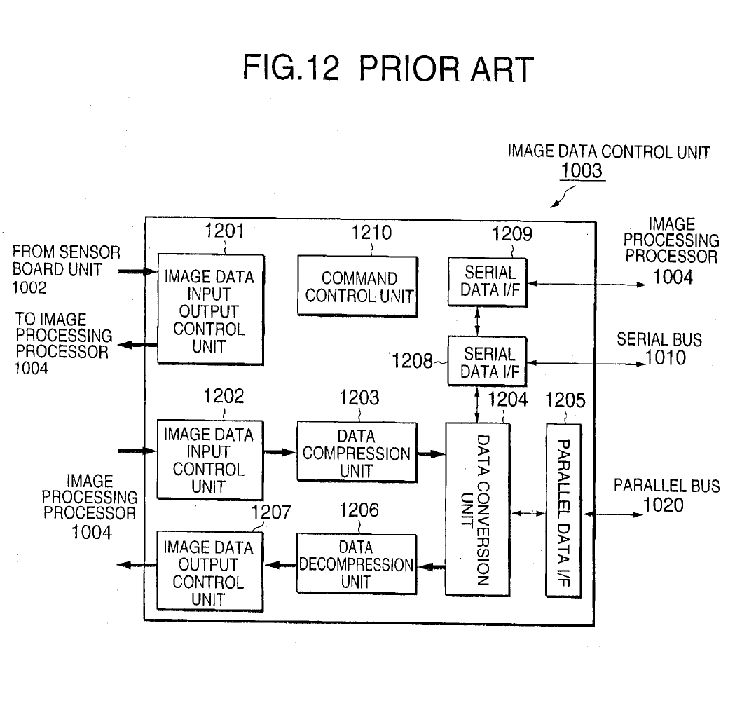

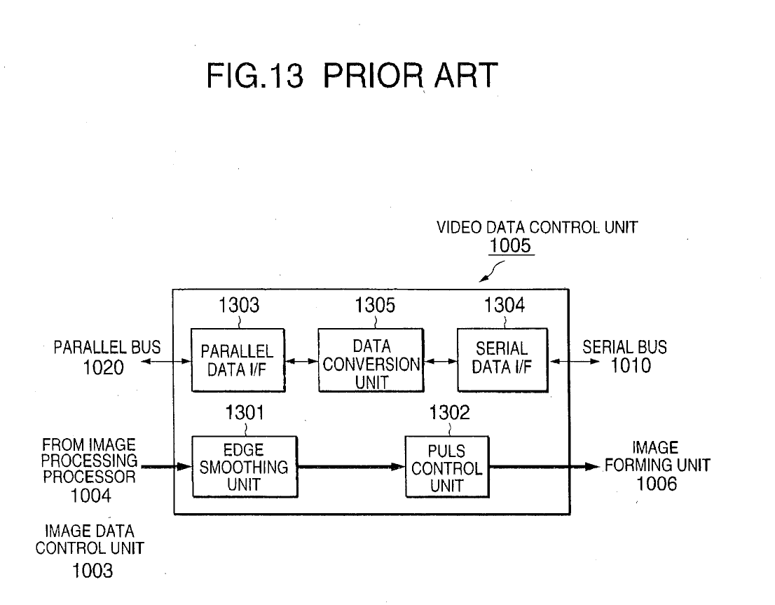

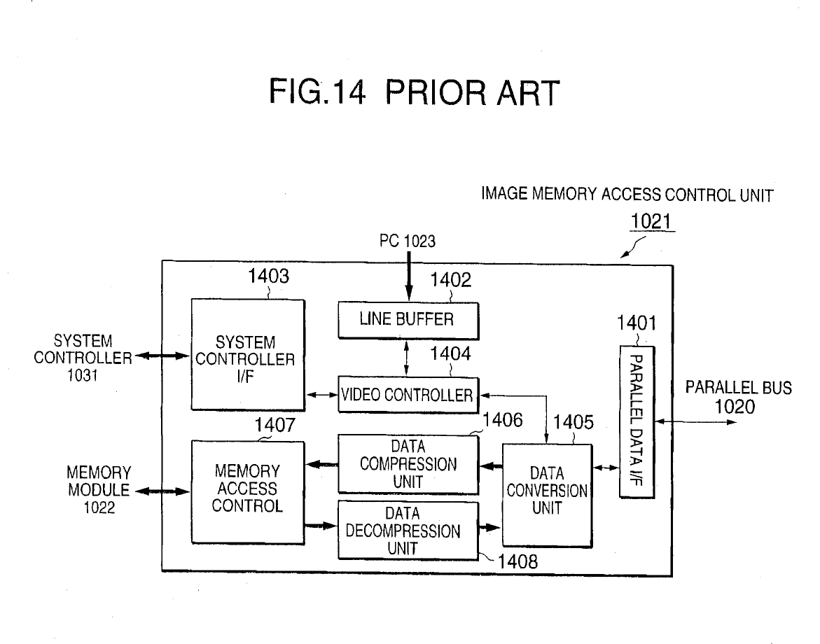

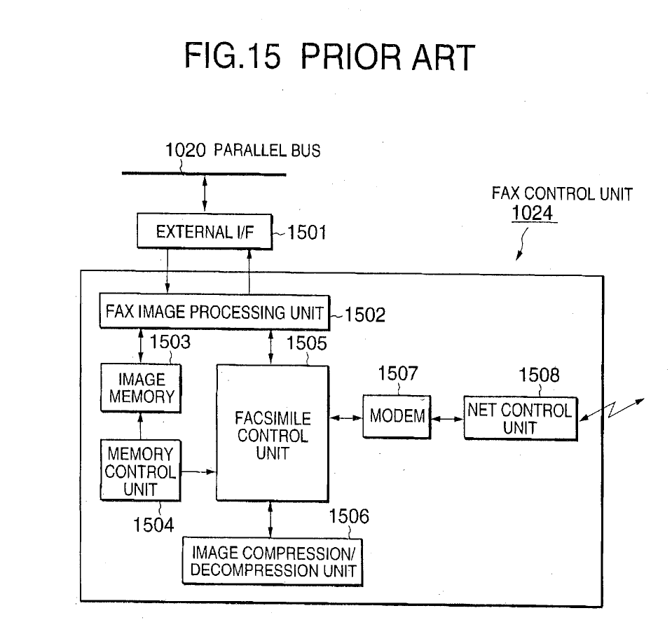

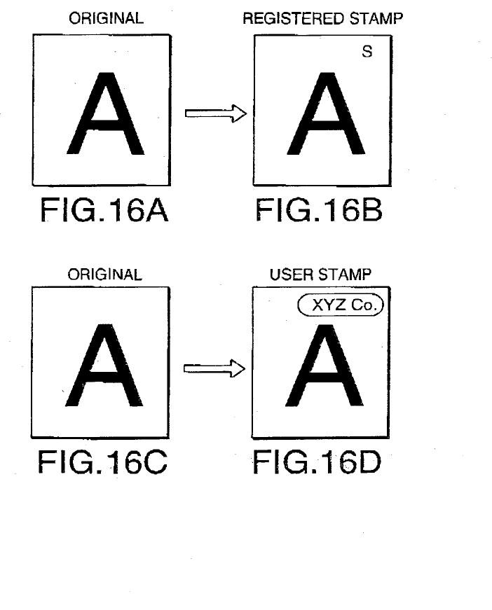

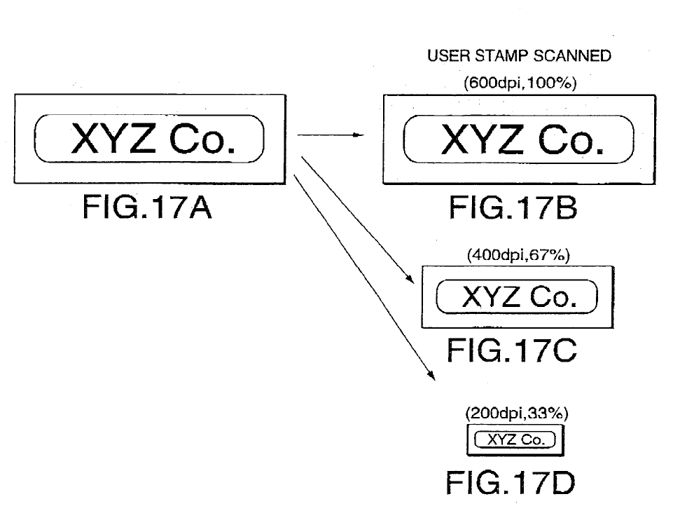

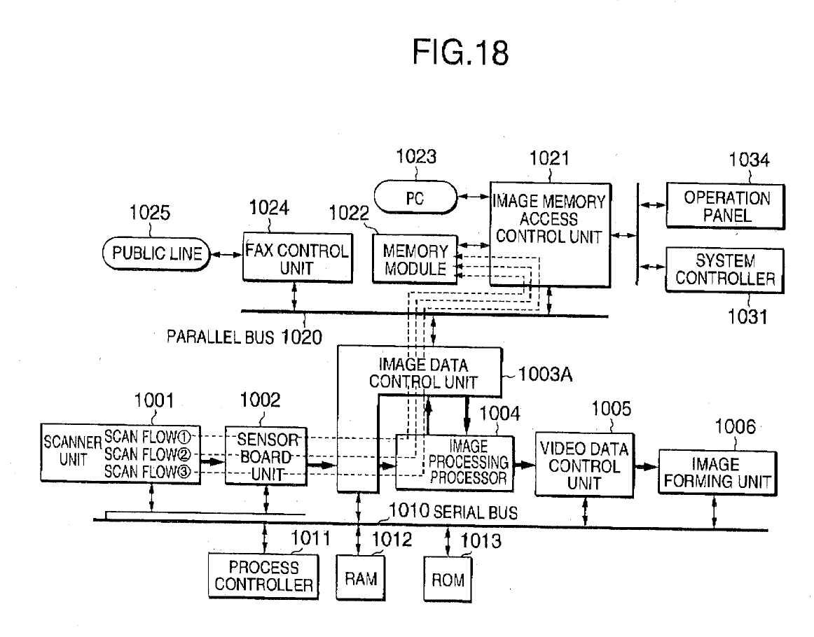

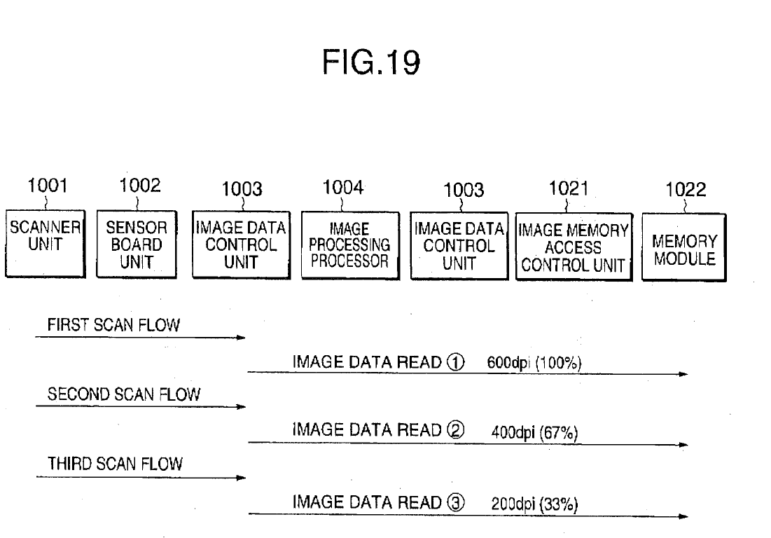

Now referring to FIG. 2, a block diagram illustrates the components of the image data control unit 1003A in the preferred embodiment according to the current invention. In comparison to the prior art structure as shown in FIG. 12, a memory output control unit 201 outputs to the temporary memory unit 101 while a memory input control unit 202 inputs the image data from the temporary memory unit 101. Furthermore, a front line & pixel removal block unit 203 is provided between the memory input control unit 202 and an image data output control unit 1207 on the way to the image processing processor 1004. A variable scaling block unit 204 is also placed between an image data input control unit 1202 and a data compression unit 1203 for enabling the image data enlargement and reduction. The image data input control unit 1202 receives data from the image processing processor 1004.

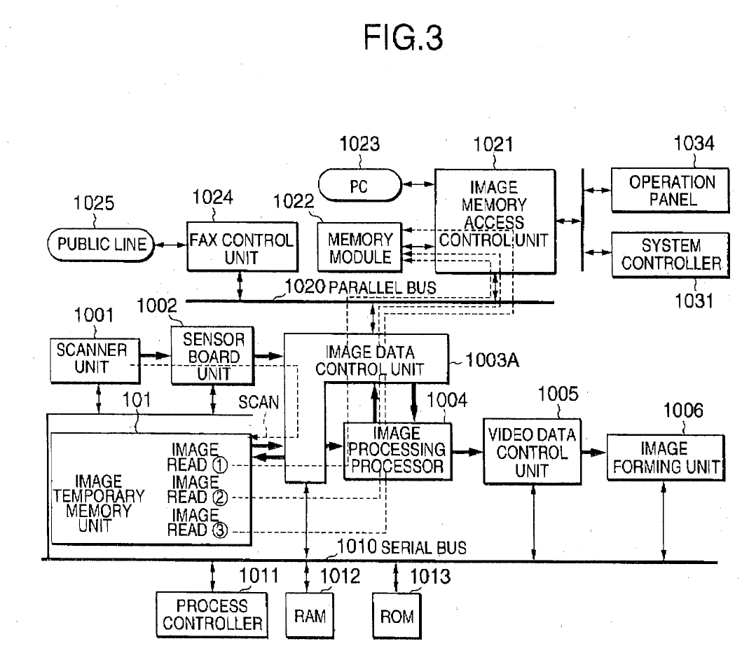

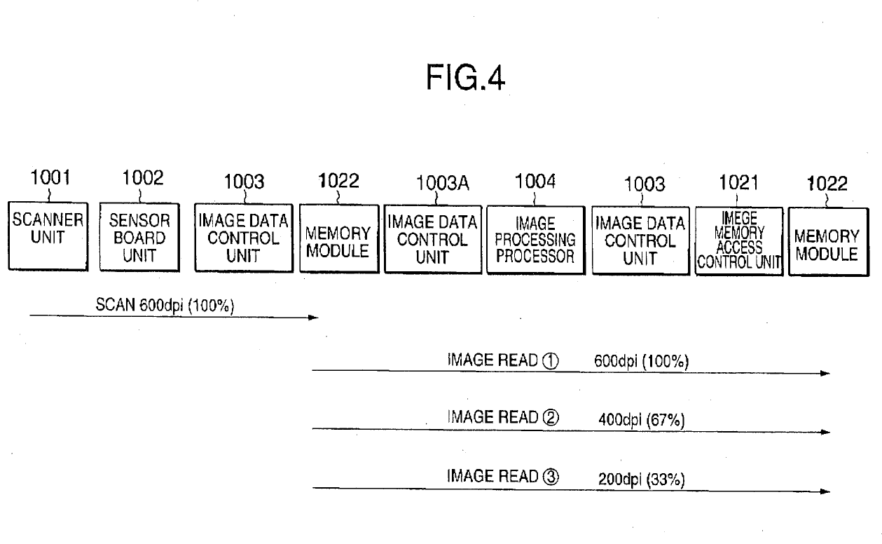

Now referring to FIG. 3, a block diagram illustrates the components of a preferred embodiment of the scanner. The diagram also illustrates a data flow in scanning an original. In conjunction with FIG. 3, FIG. 4 illustrates a data process for registering user-specified stamps. The user specific stamp image is placed in the scanner unit 1001 and is scanned. The scanned image is received by the sensor board unit 1002 and the image data control unit 1003A and is temporarily stored in the temporary memory 101. To register the user specified stamp at the size of 100%, 67% and 33% of the original size, the user specified stamp image is read from the temporary memory 101. After the specified stamp image is image processed at the image processing processor 1004, the processed image data is stored at the equal size on the controller side. The stored user specified stamp image data is read from the temporary memory 101 and is image processed at the image processing processor 1004. Then, the variable scaling block unit 204 in the image data control unit 1003A reduces the user specified stamp image to 67%, and the memory module 1022 stores the 67% reduced user specified stamp image data on the controller side. Furthermore, the user specified stamp image is read from the temporary memory 101. After the specified stamp image is image processed at the image processing processor 1004, the variable scaling block unit 204 in the image data control unit 1003A reduces the user specified stamp image to 33%, and the memory module 1022 stores the 33% reduced user specified stamp image data on the controller side. As described above, the scanner unit 1001 scans the user specified image only once, and the user specified stamp is obtained in the three desired sizes. By reducing the number of the scanning operations, the deterioration such as mechanical tear is also reduced. Because of the single scanning procedure, the registration of the user specified stamps has been simplified.

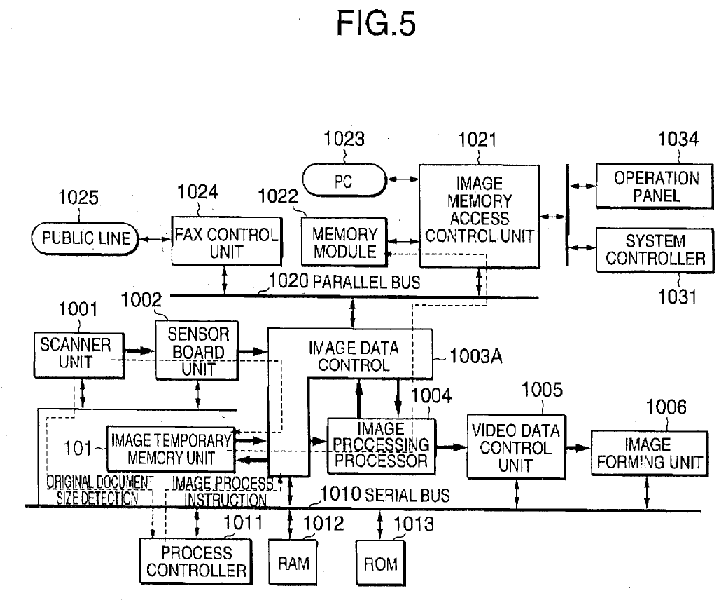

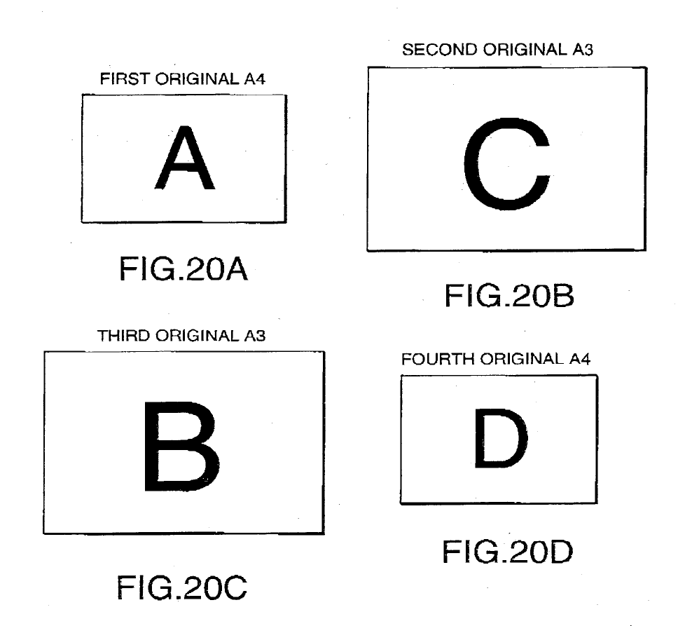

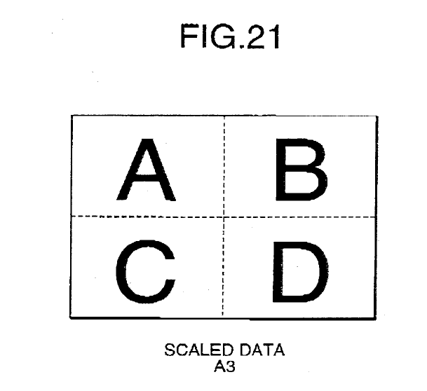

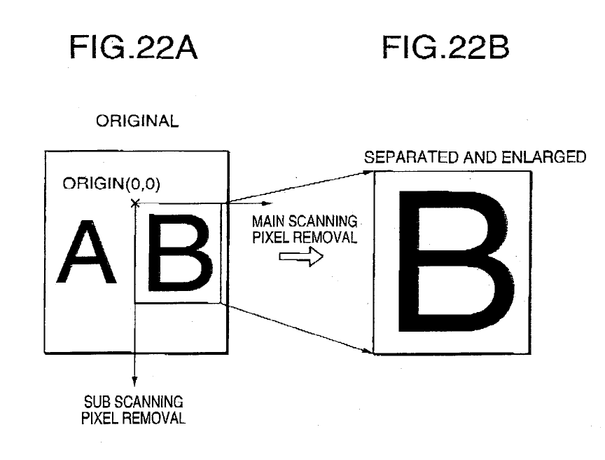

As described with respect to FIGS. 20 and 21, when a mixture of various sizes of the original documents is placed on the scanner unit 1001, the consolidation copying initially detects the original document size. Based upon the detected document size, a reduction rate is determined for each of the documents involved in the consolidation copy. Now referring to FIG. 5, a block diagram illustrates the components of the image processing system and a data flow among the components for processing original documents in a mixture of various document sizes according to the current invention. As described above, the scanner unit 1001 cannot detect the largest size among the various sizes of the original documents by a means such as an optical sensor. To enable to determine the document size, the scanner unit 1001 scans the documents to generate the scanned document image data, and the size is determined when the trailing edge of the original document image is detected. For this reason, the scanned document data is temporarily stored in the temporary memory 101 on the engine side. After the trailing edge of the document is detected and when the document size is determined, the determined document size is transferred from the scanner unit 1001 to the process controller 1011. Upon receiving the original document size, the process controller 1011 determines the document reduction rate based upon the image transfer sheet size and transfers the document reduction rate along with the image process content to the image data control unit 1003A. Subsequently, the image transmission is initiated from the temporary memory 101 to the controller side. The image process and the variable scaling are performed based upon the reduction rate that has been determined by the image data control unit 1003A and the image processing processor 1004. As a result, a desired consolidation image is obtained.

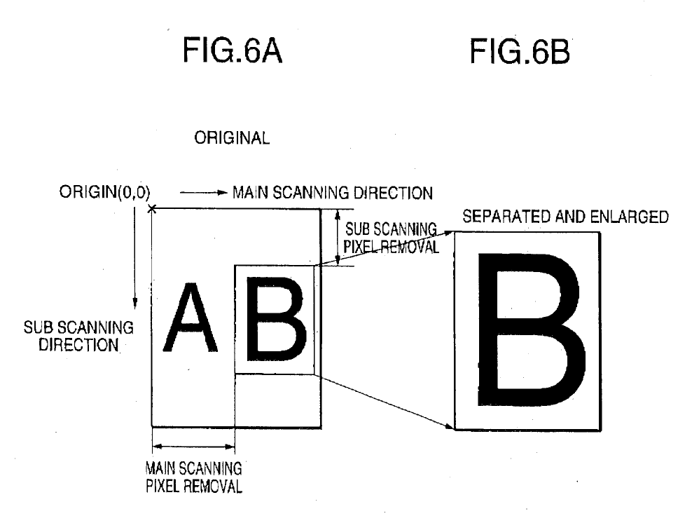

Now referring to FIG. 6, a diagram illustrates a process of separating a partial image. For example, a character “B” is separated from the original image (a) containing characters “A” and “B.” Front lines are removed in the sub-scanning direction until a predetermined separation area. Similarly, front lines are removed in the main scanning direction until a predetermined separation area. It is necessary to complete these front line removals by an internal procedure in the image data control unit 1003A before the variable scaling block. The reason is that if the front pixel removal in the main scanning direction is not performed, the unnecessary pixel lines are also processed in the variable scaling. Consequently, since the capacity exceeds in the line FIFO to be used in compression as will be later described, a desired image area is not held.

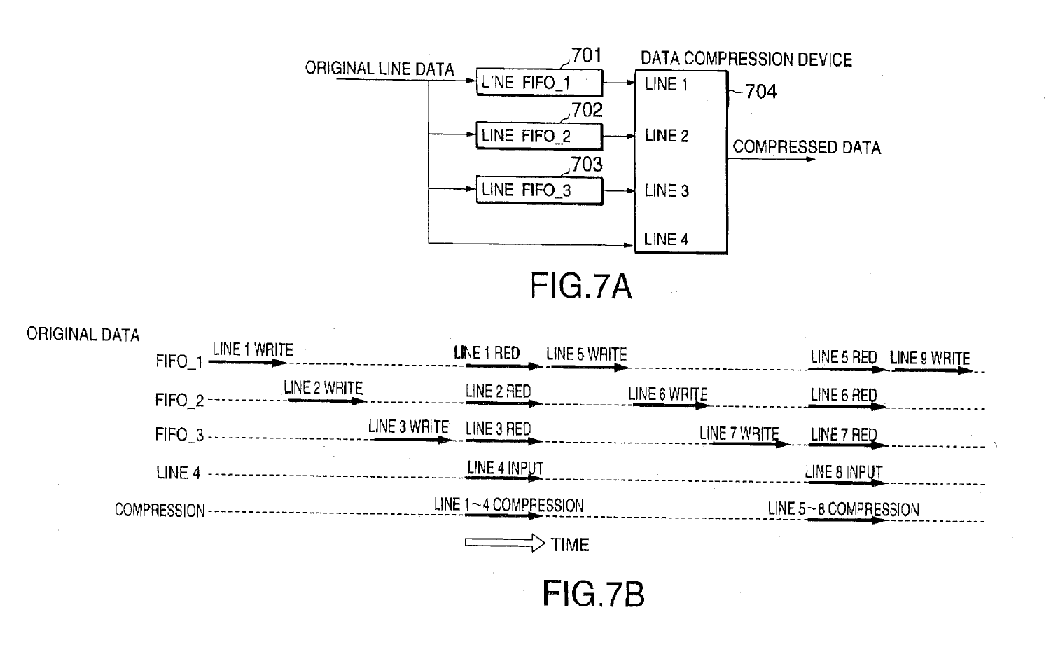

FIG. 7 includes a block diagram and a timing chart for controlling data in compressing data at the data compression unit 1203 in the image data control unit 1003A. The data compression unit 1203 is arranged behind the variable scaling block unit 204 as shown in FIG. 2. As shown in FIG. 7(a), the data compression unit 1203 further includes three line FIFO's 701 through 703 and a data compression device 704. The line FIFO_1 701 stores a first line of the image area in the 4×4 image area. Assuming an A4 size, one line of 297 mm and 600 dpi, approximately 8000 pixels exist in one line. Since each pixel is represented by one byte, the line FIFO_1 701 has a capacity of 8 K bytes or 8 thousand bytes. Similarly, the line FIFO_2 702 stores a second line of the image area in the 4×4 image area while the line FIFO_3 703 stores a third line of the image area in the 4×4 image area. As shown in the timing chart FIG. 7(b), upon inputting the fourth line, the first through third lines of the image are read from the line FIFO's 701 through 703 and are inputted in the data compression device 704 to obtain the compressed data. Since the line FIFO's 701 through 703 store the pixel data that only corresponds to one line of 297 mm of the A4 size, if the unnecessary front pixels are enlarged in the above described partial image separation process, since the data is to be stored in the line FIFO's 701 through 703, the enlarged image data exceeds the capacity of the line FIFO's 701 through 703. Consequently, the enlarged separated image is not obtained. For this reason, as shown in FIG. 2, the image data control unit 1003A includes the front line & pixel removal block unit 203 for removing a front line and front pixels in the image data from the image temporary memory 101 on the engine side. In case of the image separation as shown in FIG. 6, unnecessary front line and pixels are removed, and only necessary image data is transferred to any subsequent pass. The front pixel removal prevents the pixel data from exceeding the capacity of the line FIFO 701 through 703. Furthermore, the front line removal removes unnecessary line data to save the unnecessary processing time. By keeping the capacity of the line FIFO 701 through 703 to the minimal, the circuit is also prevented from enlarging. The above described procedures enable the image isolation at a high speed without unnecessary process, and the desired image data is obtained. Since a necessary image area is specified by the coordinates and the isolated area is correctly specified, a user-intended area is isolated at a high precision level.

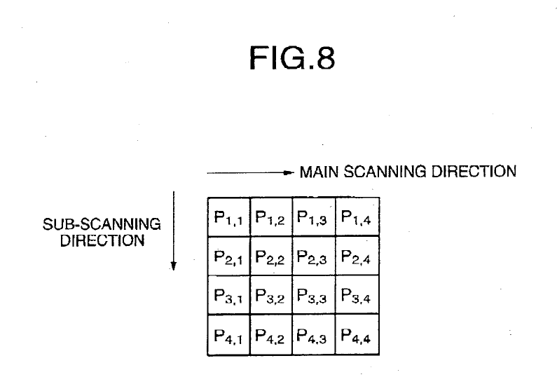

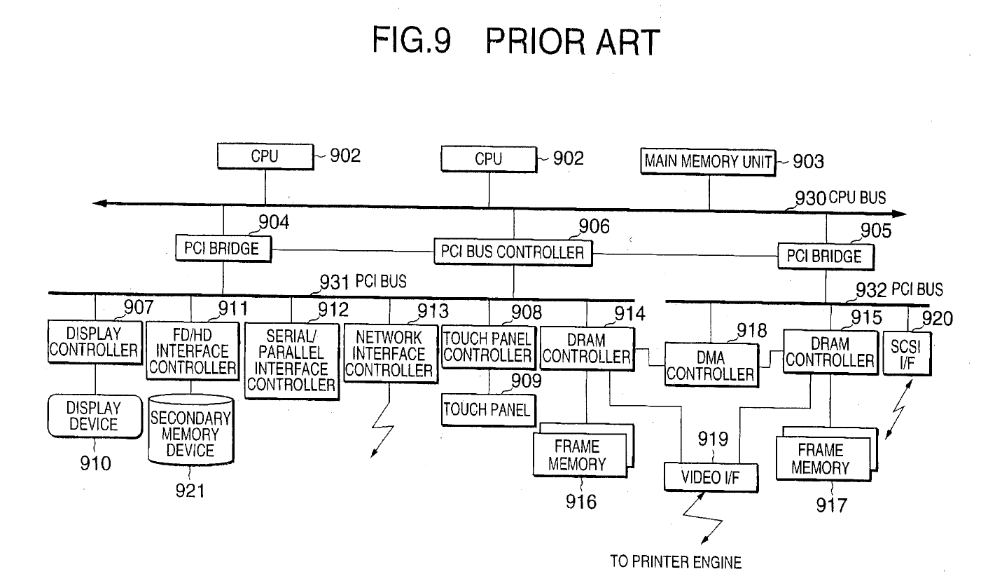

Now referring to FIG. 8, a table illustrates an exemplary data compression at the data compression device. A predetermined compression is repeated for each 4×4 pixel area. One pixel has eight bits, and for the 4×4 area, there are 128 bits as 4×4×8. The 128 bits are compressed by one fourth to 32 bits.

The above described preferred embodiments and processes are implemented in predetermined computer programs that are executed in a personal computer or a workstation. The software programs are recorded in a computer readable/recording media such as a hard disk, a floppy disk, a CD-ROM, MO and DVD. The computer reads the software and executes it. The software program is distributed via the above recording media over networks such as the Internet.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. An image processing apparatus comprising:
a controller block having a converter for converting scanned image data of an original document to digital image signal, said controller block having an image memory for storing the digital image signal; and
an engine block connected to said controller block for processing the digital image data, said engine block having a temporary memory for storing the digital image data, said engine block retrieving the digital image from said temporary memory for further processing.

2. The image processing apparatus according to claim 1 wherein said engine block performs an image process on a unit of the digital image data read from said temporary memory, the image process including enlargement and reduction, the processed digital image data being stored in said image memory in said controller block.

3. The image processing apparatus according to claim 2 wherein said engine block retrieves the digital image from said temporary memory after a size of the original document is determined, the image process being performed based upon the size, the processed image data being stored in said image memory in said controller block.

4. The image processing apparatus according to claim 3 wherein said engine block further comprising a front line and pixel removal unit for removing lines and pixel before reading the image data from said temporary memory.

5. The image processing apparatus according to claim 4 wherein said front line and pixel removal unit removes the lines and pixels based upon a scaling ratio for enlargement and reduction.

6. The image processing apparatus according to claim 4 wherein said front line and pixel removal unit removes the lines and pixels based upon a position of an image separation.

7. A method of image processing comprising the steps of:
converting scanned image data of an original document image to a digital image signal in a control block;
processing the digital image to a usable image signal in the control block;
storing the usable image signal in an image memory in the control block;
storing the image signal in a temporary memory in an engine block;
reading the image signal from the temporary memory in response to a request from the control block; and
transferring the image signal from the temporary memory to the control block.

8. The method of image processing according to claim 7 further comprising an additional step of further processing the image signal that has been read from the temporary memory in response to the request from the control block.

9. The method of image processing according to claim 8 wherein said further processing includes enlargement and reduction of the original document image.

10. A method of duplicating user specified stamps, comprising the steps of:
scanning a user specified stamp to generate image data;
storing the image data in a temporary storage;
reading the image data from the temporary storage;
processing the image data read from the temporary storage based upon a parameter; and
repeating said reading and processing steps with a different value in the parameter.

11. The method of duplicating user specified stamps according to claim 10 wherein the user specified stamp includes a name of a company, a duplication prohibition label and a confidential label.

12. The method of duplicating user specified stamps according to claim 11 wherein the user specified stamp is scaled according to a set of predetermined scaling factors.

13. The method of duplicating user specified stamps according to claim 11 wherein the user specified stamp is scaled according to a paper size.

14. The method of duplicating user specified stamps according to claim 11 wherein said reading step further including an additional steps of:
separating a part of the image data; and
removing an area outside of the separated part of the image data.
